(19) United States
(12) Patent Application Publication
(10) Pub. No.: US 2011/0250572 A1
(43) Pub. Date: Oct. 13, 2011

(54) TILE TOOL AND SYSTEM FOR TEACHING MATH

(76) Inventors: Mickelle Weary, Kirkland, WA (US); Catherine Twomey Fosnot, New London, CT (US); Beth Dudycha, Mercer Island, WA (US); Laura Koch, Seattle, WA (US); David Fedchenko, Seattle, WA (US); Nigel J. Green, Bellevue, WA (US); Aja M. Hammerly, Seattle, WA (US); Daniel R. Kerns, Mercer Island, WA (US); Rebecca M. Lewis, Tacoma, WA (US); Slavi Marinov Marinov, Varna (BG); Valentin Mihov, Sofia (BG); Petia Radeva, Sofia (BG)

(21) Appl. No.: 13/082,353

(22) Filed: Apr. 7, 2011

Related U.S. Application Data
(60) Provisional application No. 61/321,843, filed on Apr. 7, 2010.

(51) Int. Cl. G09B 5/02

(52) U.S. Cl. 434/188

(57) ABSTRACT

A computer-implemented method for teaching math is disclosed. The method comprises displaying a challenge for a learner to solve; displaying in first area a plurality of moveable pieces; displaying a second area defining a receptacle to which the learner can move the moveable pieces in attempting to solve the challenge; and evaluating the learner's response to the challenge.

This application claims the benefit of priority of U.S. 61/321,843, filed Apr. 7, 2010, the entire specification of which is hereby incorporated herein by reference.

### FIELD

Embodiments of the present invention relate generally to software and systems designed for teaching purposes.

### BACKGROUND OF THE INVENTION

Concrete or physical manipulatives such as blocks, math racks, counter, etc., are used to facilitate learning, especially in the field of mathematics. Virtual manipulatives refer to digital “objects” that are the digital or virtual counterpart of concrete manipulatives. Virtual manipulatives may be manipulated, e.g., with a pointing device such as a mouse during learning activities.

### BRIEF DESCRIPTION OF THE DRAWINGS

FIGS. 1 to 5 show screenshots of a User Interface generated by the tile tool and system of the present invention.

FIG. 6 shows an example of hardware for implementing the tile tool and system, in accordance with one embodiment of the invention.

### SUMMARY

Broadly, embodiments of the invention disclose a tile tool and a method for teaching math based on the tile tool. The tile tool may comprise a plurality of tiles, a tile receptacle, a tile bin, and a problem description. In particular, users are given a row of tiles that they can move to the tile receptacle to create multiplication representations. The multiplication representations may then either be described, with words (for example, “3 groups of 5 makes 15”) or symbolically (“3×5=15”) or the student may be asked to fill in a missing part of the description. Advantageously, the tile tool supports students as they begin to understand the concept of early multiplication. It allow students to work from a more concrete representation where all tiles are countable to a more symbolic representation where tiles are occluded to disallow counting individual items.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrases “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not other embodiments.

Broadly, embodiments of the invention disclose a tile tool and a method for teaching math based on the tile tool. The tile tool may comprise a plurality of tiles, a tile receptacle, a tile bin, and a problem description. In particular, users are given a row of tiles that they can move to the tile receptacle to create multiplication representations. The multiplication representations may then either be described, with words (for example, “3 groups of 5 makes 15”) or symbolically (“3×5=15”) or the student may be asked to fill in a missing part of the description. Advantageously, the tile tool supports students as they begin to understand the concept of early multiplication. It allow students to work from a more concrete representation where all tiles are countable to a more symbolic representation where tiles are occluded to disallow counting individual items.

Advantageously, in one embodiment the tile tool may be rendered as a virtual manipulative on a display screen so that a learner may interact with the virtual manipulative to solve math problems and to learn math problem solving techniques.

The tile tool may be integrated in a system for teaching math. The system may be realized, in one, embodiment, as a general-purpose computer comprising suitable instructions for implementing the tile tool and associated method.

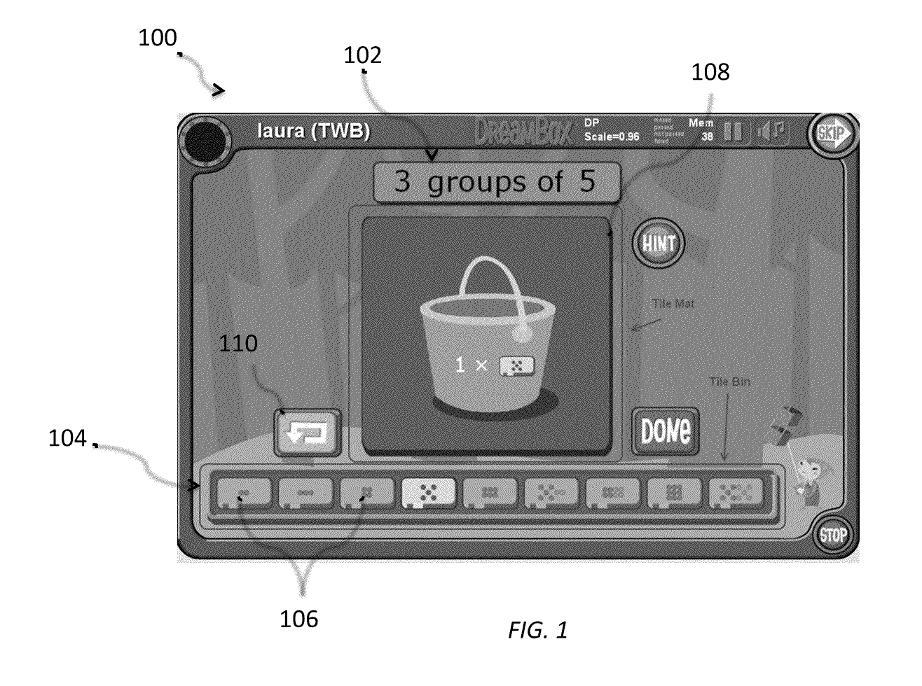

Referring to FIG. 1, there is shown a user interface (UI) 100 generated by the tile tool, in accordance with one embodiment of the invention. As will be seen, the UI 100 comprises a problem box 102, in which a problem to be presented. In accordance with various embodiments, problems may be presented as word descriptions (for example, “3 groups of 5 makes 15”) or symbolically (“3×5=15”). Alternatively, a student may be asked to fill in a missing part of the description, as is the case with the problem shown in the UI 100.

The user interface 100 also includes a tile bin 104. A plurality of tiles 106 may initially be located within the tile bin 104. In one embodiment, the user interface 100 includes a tile receptacle in the form of a tile mat or basket 108 located above the tile bin 104. In use a student moves tiles 106 from the tile bin 104 into the tile mat 108 in order to solve problems.

### Tile Bins:

In one embodiment, students struggling with the early multiplication concept of grouping may be given a smaller number of tiles with smaller amounts. This allows them to start with numbers they may find easier to work with such as 1-5.

In one embodiment tiles may show dots (numbergrams), numerals or animals.

In one embodiment a user may be allowed to drag tiles to mat or back to bin. This enables a student to self-correct.

In one embodiment, only specific tiles may be moveable.

### Receptacle:

The receptacle may take the form of a bucket, mat, or basket, in accordance with different embodiments.

In one embodiment, a reset button (see 110 in FIG. 1) may be provided value to allow a student to reset the receptacle to zero.

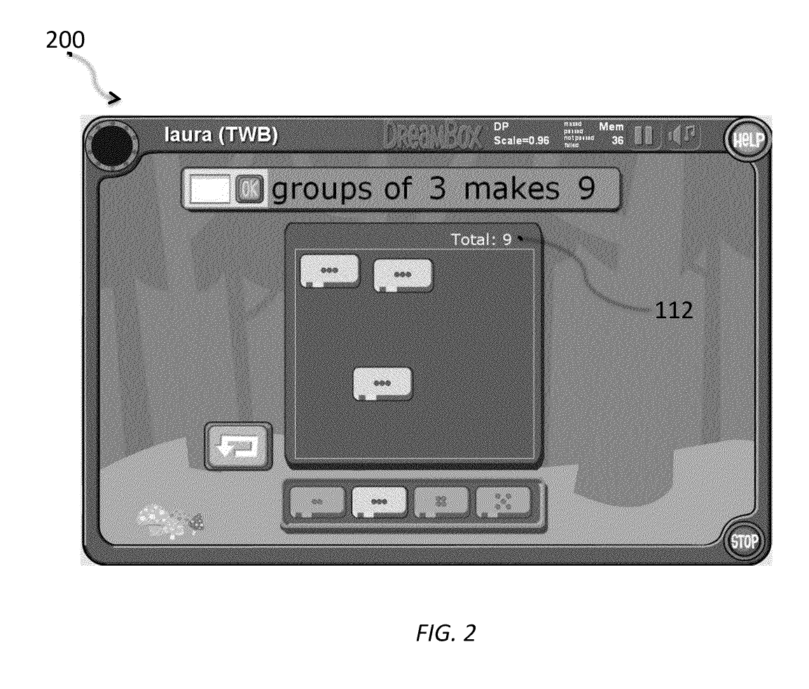

In one embodiment a counter for the total in the receptacle (see 112 in FIG. 2) may be selectively turned on or off. Students working to find a factor for a specific number are supported by showing the total as they build the number with tiles.

In one embodiment, the tile tool may allow a student to highlight and count off tiles in the receptacle. This gives students a visual and auditory model for skip counting.

In one embodiment, tile tool may arrange tiles on mat in arrays with rows of e.g. 5 for easier skip counting. This reinforces using multiples of 5 and 10 to help skip count.

In one embodiment, tile tool may allow students to choose placement of tiles on the mat. This allows students to group tiles in ways that support the development of multiplicative thinking.

Referring now to FIG. 2, UI 200 students are given a group of tiles and asked to choose a group that will make a target number. Once a tile is placed on the mat, the student may add more tiles to build the target number or type in the answer to the problem.

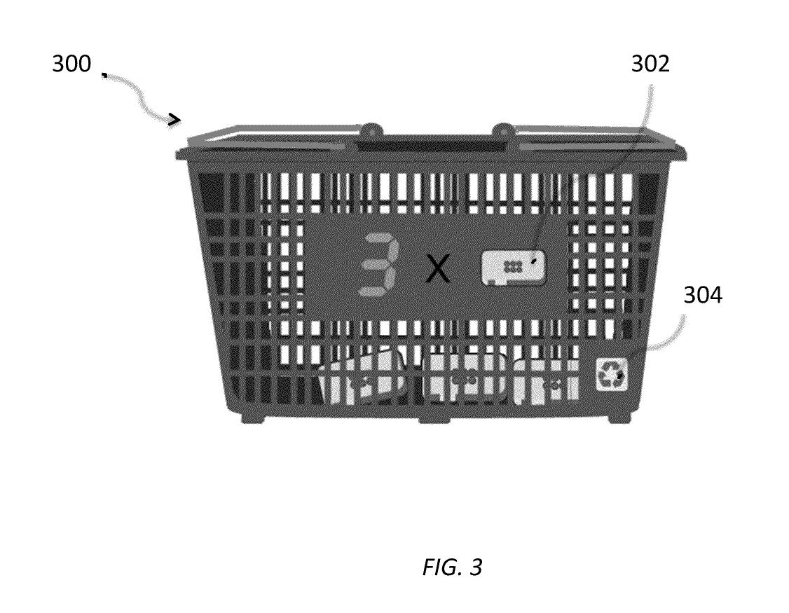

FIG. 3 shows an embodiment of the receptacle in the form of a basket 300. A counter 302 shows the number of tiles in the basket and a recycle/empty button 304 may be used to return the tiles in the basket 300 back to the tile bin (not shown).

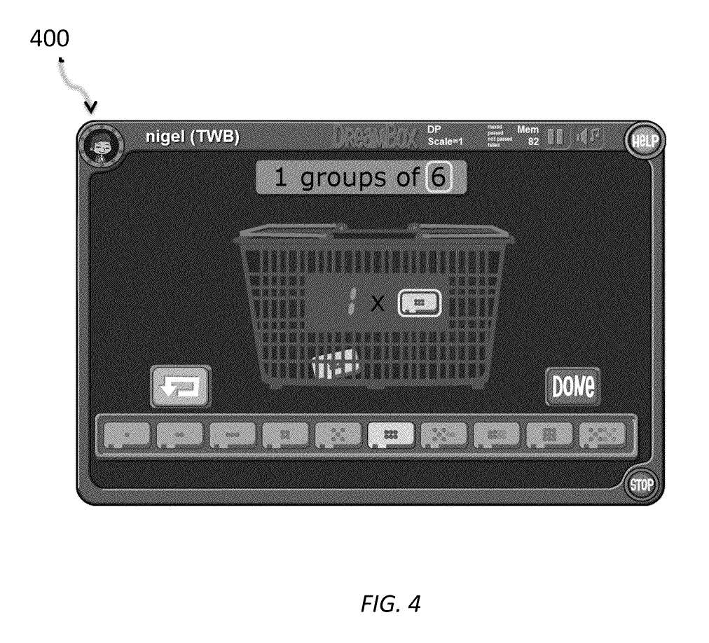

FIG. 4 shows a UI 400 in which tiles in the tile bin have values indicated by numbergrams. The correspondence between the equation in the problem box and the tiles in the basket is clearly highlighted.

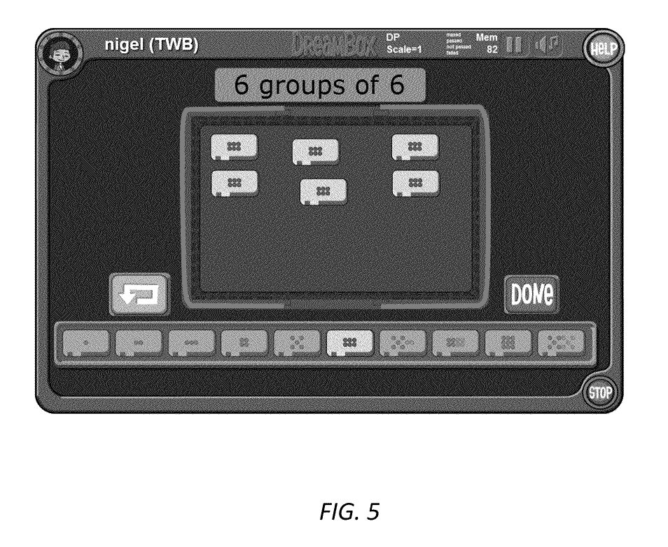

FIG. 5 shows a top view of a tile basket showing how a student has organized three groups of 2 sixes each.

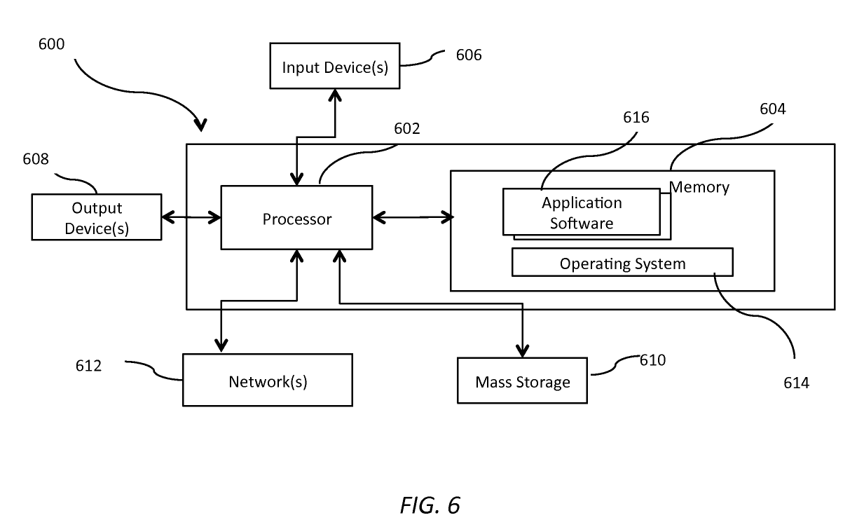

FIG. 6 of the drawings shows an example of hardware 600 that may be used to implement the tile tool in accordance with one embodiment. The hardware 600 may include at least one processor 602 coupled to a memory 604. The processor 602 may represent one or more processors (e.g., microprocessors), and the memory 604 may represent random access memory (RAM) devices comprising a main storage of the system 600, as well as any supplemental levels of memory e.g., cache memories, non-volatile or back-up memories (e.g. programmable or flash memories), read-only memories, etc. In addition, the memory 604 may be considered to include memory storage physically located elsewhere in the system 600, e.g. any cache memory in the processor 602 as well as any storage capacity used as a virtual memory, e.g., as stored on a mass storage device 600.

The system 600 also typically receives a number of inputs and outputs for communicating information externally. For interface with a user or operator, the system 600 may include one or more user input devices 606 (e.g., a keyboard, a mouse, imaging device, etc.) and one or more output devices 608 (e.g., a Liquid Crystal Display (LCD) panel, a sound playback device (speaker, etc.).

For additional storage, the system 600 may also include one or more mass storage devices 610, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 600 may include an interface with one or more networks 612 (e.g., a local area network (LAN), a wide area network (WAN), a wireless network, and/or the Internet among others) to permit the communication of information with other computers coupled to the networks. It should be appreciated that the system 600 typically includes suitable analog and/or digital interfaces between the processor 602 and each of the components 604, 606, 608, and 612 as is well known in the art.

The system 600 operates under the control of an operating system 614, and executes various computer software applications, components, programs, objects, modules, etc. to implement the techniques described above. Moreover, various applications, components, programs, objects, etc., collectively indicated by reference 616 in FIG. 6, may also execute on one or more processors in another computer coupled to the system 600 via a network 612, e.g. in a distributed computing environment, whereby the processing required to implement the functions of a computer program may be allocated to multiple computers over a network. The application software 616 may include a set of instructions which, when executed by the processor 612, causes the system 610 to generate the tile tool described.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others.

Although the present invention has been described with reference to specific example embodiments, it will be evident that various modifications and changes can be made to these embodiments without departing from the broader spirit of the invention. Accordingly, the specification and drawings are to be regarded in an illustrative sense rather than in a restrictive sense.

1. A computer-implemented method for teaching math, comprising:
displaying a challenge for a learner to solve;
displaying in first area a plurality of moveable pieces;
displaying a second area defining a receptacle to which the learner can move the moveable pieces in attempting to solve the challenge; and
evaluating the learner's response to the challenge.

2. The method of claim 1, wherein the challenge is a problem stated in words.

3. The method of claim 1, wherein the challenge is a problem stated symbolically.

4. The method of claim 1, wherein the second area resembles a mat.

5. The method of claim 1, wherein the second area resembles one of a bucket and a basket.

6. The method of claim 1, wherein the moveable pieces have one of a number or a numbergram marked thereon.

7. The method of claim 1, further comprising not allowing some of the moveable pieces to be moved into the second area.

8. The method of claim 1, further comprising arranging at least some of the moveable pieces in the second area for easier skip counting.

9. A system, comprising:
a processor; and
a memory coupled to the processor, the memory storing instructions which when executed by the processor causes the system to perform a method for teaching math, comprising:
displaying a challenge for a learner to solve;
displaying in first area a plurality of moveable pieces;
displaying a second area defining a receptacle to which the learner can move the moveable pieces in attempting to solve the challenge; and
evaluating the learner's response to the challenge.

10. The system of claim 10, wherein the challenge is a problem stated in words.

11. The system of claim 10, wherein the challenge is a problem stated symbolically.

12. The system of claim 10, wherein the second area resembles mat.

13. The system of claim 10, wherein the second area resembles a one of a bucket and a basket.

14. The system of claim 10, wherein the moveable pieces have one of a number or a numbergram marked thereon.

15. The system of claim 10, wherein the method further comprises not allowing some of the moveable pieces to be moved into the second area.

16. The system of claim 9, wherein the method further comprises arranging at least some of the moveable pieces in the second area for easier skip counting.

17. A computer-readable medium having stored thereon a sequence of instruction which when executed by a system causes the system to perform a method, comprising:
displaying a challenge for a learner to solve;
displaying in first area a plurality of moveable pieces;
displaying a second area defining a receptacle to which the learner can move the moveable pieces in attempting to solve the challenge; and
evaluating the learner's response to the challenge.

18. The computer-readable medium of claim 17, wherein the challenge is a problem stated in words.

19. The computer-readable medium of claim 17, wherein the challenge is a problem stated symbolically.

20. The computer-readable medium of claim 17, wherein the moveable pieces have on of a number or a numbergram marked thereon.
